(19) United States
(12) Patent Application Publication
(10) Pub. No.: US 2018/0187973 A1
(43) Pub. Date: Jul. 5, 2018

(54) Process and Plant for Processing and Drying of Solid Materials in Small Pieces

(71) Applicant: CEBCON Technologies GmbH, Hamburg (DE)

(72) Inventor: Valery Detzel, Hamburg (DE)

(73) Assignee: CEBCON Technologies GmbH, Hamburg (DE)

(21) Appl. No.: 15/740,479

(22) PCT Filed: Jul. 2, 2015
(86) PCT No.: PCT/EP2015/065100

§ 371 Date: Dec. 28, 2017

(51) Int. Cl. F26B 3/16; F26B 17/12; F26B 21/04

(52) U.S. Cl. CPC F26B 3/16; F26B 2200/24; F26B 21/04; F26B 17/122

(57) ABSTRACT

A process and plant for drying of wood shavings, wood chips or other solid materials of organic and/or mineral origin in small pieces, in which—the material is predried by means of a first preheated drying gas in a first drying step,—the dried material from the first drying step is dried by means of a second preheated drying gas in a second drying step,—ambient air is heated and supplied as second preheated drying gas to the second drying step,—the dried material from the second drying step is cooled by means of a cooling gas, and—the cooling gas heated by cooling of the material and/or the second drying gas cooled in the second drying step is supplied as first drying gas to the first drying step.

The invention relates to a method and a plant for the drying of wood shavings, woodchips or other solid materials in small pieces that are of organic and/or mineral origin. The materials consist of a plurality of solid particles and are pourable. They are also called bulk material or piles. The method according to the invention and the plant according to the invention are suitable in particular for use in a method and a plant for producing wood pellets or other solid granules from material in small pieces that are of organic and/or mineral origin.

Wood pellets are rod-shaped granules that consist of sawing or planing shavings, wood chips, wood shredder material or other byproducts, or waste from the timber and forest industry. Other solid granules made of material in small pieces that are of organic and/or mineral origin can be made for example of straw, sunflower seed shells, olive pits, olive press pomace, rice husks, meat or fish waste and other biogenic remnants from the agriculture industry, meat, fish or food industry among other things with the addition of mineral components in different combinations and proportions. In the production of wood pellets, the supplied material is prepared to be pelletized, in particular by drying, if applicable also by maceration and conditioning. The pellets are pressed from the prepared material. For this, an edge runner press for example is used in which the material is pressed through a die with holes according to the desired pellet diameter. The lignin contained in the material is released by the heating during conditioning, or respectively during the pressing, and bonds the individual wood particles to each other. Furthermore, it is known to add bonding agent to the granulated material in order to bond the particles together. After exiting the die, a knife cuts the pellet strands to the desired length. Then the pellets are cooled and thereby solidified.

DE 10 2013 224 204 A1 describes a plant for producing wood pellets or other solid granules that can be transported, set up and moved to a different location with less effort, and that enables energy-optimized operation. The plant is arranged at least partially in individual transportable containers that can be assembled in a modular manner for at least a substantial part of the plant, wherein at least the apparatus for cooling designed as a duct cooler is completely arranged in a container. At least one of the apparatuses for adding, preparing, drying, pressing, cooling and discharging is arranged in a container with a vertical longitudinal axis. In the exemplary embodiment, the dryer is a belt dryer, and a storage silo for intermediate storage is arranged downstream of the dryer. From the storage silo, the material is conveyed to the dry mill, where it is crushed to the optimal particle size.

During the drying in the belt dryer, heat loss occurs due to the fact that the heated air is released into the atmosphere after crossing over the belt and the drying material lying on it. Since a heterogeneous drying takes place, in practice only the uppermost layer is often scratched off and the layer lying underneath it is fed back to the drying. Energy loss for the operation of the powerful ventilators is added to the high heat loss.

Drying in drum dryers is also known. These work with a burner, which heats the heating gas to a very high temperature e.g. of 400° C. The waste heat still has a high temperature of e.g. 90° C. and is not used. It is also disadvantageous that volatile organic compounds (VOCs) and lignins are leached from wood particles. The quality of the material is hereby reduced. The lignin is missing as the bonding agent during the pelletization.

DE 10 2006 061 340 B3 describes an apparatus for producing wood pellets with at least one assembly module for adding, drying, pressing and discharging. The assembly modules are introduced in a vertical arrangement of the respective functional assemblies in internationally standard containers (12 to 20 foot containers). A plurality of containers forming a horizontal and/or vertical row are connected to each other by electrical and/or pneumatic media lines, and one of the containers is connectable to a locally available media source. The easy and quick assembly of the plant is advantageous which consists of prepared assembly modules.

The plant comprises a dryer, which comprises vertical drying ducts for wood shavings, which extend over two containers set horizontally to each other. On the top, wood shavings enter the drying duct and exit again on the bottom end. Ventilators and heat exchangers, which are arranged on different sides of the drying duct, ensure dehumidification of the wood shavings. The upper ventilator suctions air heated by the upper heat exchanger through the drying duct and the lower ventilator suctions air heated by the lower heat exchanger in the opposite direction through the drying duct. A high throughput should hereby be achieved. The drying air suctioned through the drying duct is released to the surroundings. The flexibility with respect to an adjustment of the dryer to different throughputs is low.

Based on this, the object of the invention is to create a method and a plant for the drying of wood shavings, woodchips or other solid materials in small pieces that are of organic and/or mineral origin with improved energy efficiency and increased flexibility.

The object is solved by the inventive method.

The method according to the invention for the drying of wood shavings, woodchips or other solid materials in small pieces that are of organic and/or mineral origin includes the following steps:
in a first drying step, the material is pre-dried by means of a first preheated drying gas,
in a second drying step, the dried material from the first drying step is dried by means of a second preheated drying gas,
ambient air is heated and supplied to the second drying step as a second preheated drying gas,
the dried material from the second drying step is cooled by means of a cooling gas and
the cooling gas heated by the cooling of the material and/or the second drying gas cooled in the second drying step is supplied to the first drying step as the first drying gas.

In the case of the method according to the invention, energy is saved through the repeated use of the energy for the heating of the ambient air. For this, the second drying gas is also used in the first drying step after cooling down in the second drying step and/or the thermal energy bound in the material is used for drying in the first drying step. The drying gas is preferably air or a mixture of combustion gas and air.

According to a preferred embodiment of the invention, in a third drying step, the dried material from the second drying step is dried by means of the second preheated drying gas and the second preheated drying gas cooled in the third drying step to a temperature above the temperature of the ambient air is supplied to the second drying step. In this embodiment, the energy of the second preheated drying gas is used for the third drying step and the second drying step and the energy efficiency is further improved. The dried material from the second drying step is cooled by means of the cooling gas only after passing through the third drying step.

Furthermore, the invention includes embodiments, in which the material passes through more than three drying steps. The second preheated drying gas is preferably first used for the respective last drying step and after a cooling down to a temperature above the ambient temperature for at least one upstream drying step.

According to a further embodiment, the dried material from the first or the second drying step undergoes a rest period, in which the water content within the particles of the material are more or less equalized and the material is dried in the second or third drying step after the rest period is complete. During the rest period, which is preferably one half to two hours, further preferably one to one and a half hours, an equalization of the water content of the cross-section of the particles more or less results so that water moves from the core to the surface of the particles. The efficiency of the subsequent drying step is hereby improved.

According to a further embodiment, the dried material from the first drying step or from the second drying step is macerated and then supplied to the second drying step or the third drying step. Through the maceration of the material, the humidity inside the particles on the surface is freed so that the subsequent drying can be performed more efficiently.

According to a further embodiment, the dried material is macerated between two drying steps and undergoes a rest period. The maceration and rest period can take place in any order. The particles are preferably first macerated and then undergo a rest period. The dried material is preferably macerated between the same drying steps and undergoes a rest period. The invention further comprises designs in which the maceration takes place between two different drying steps than the rest period.

According to a further embodiment, the cooled and humidified drying gas from the first drying step and/or from the second drying step is released into the surroundings. In this embodiment, largely cooled drying gas is released into the surroundings.

According to a further embodiment, the cooled and humidified drying gas from the second drying step is dried and the dried drying gas is mixed with the ambient air and is supplied to the second or third drying step as a second drying gas. In this embodiment, the remaining thermal energy of the drying gas from the second drying step is used for the heating of the ambient air.

According to a further embodiment, the condensed water coming from the drying of the drying gas from the second drying step is supplied to a heat pump and the heat brought to an increased temperature level by the heat pump is used to heat the ambient air. The energy bound in the water in the drying air is hereby also reclaimed for the process and the energy efficiency is further improved.

According to a further embodiment, a portion of the cooled, second drying gas from the third drying step is mixed with the heated cooling gas and is supplied to the first drying step as the first drying gas. The usage of the thermal energy of the second drying gas is hereby further improved.

According to a further embodiment, the ambient air and/or the dried drying gas is heated by means of a heat exchanger and/or by means of a heat burner. According to one embodiment, the heat exchanger is operated by means of the energy supplied by the heat pump and/or with the waste heat from a production process and/or with the heat from a block heat and power plant. When using a heat burner, wood dust or wood pellets from the method or another fossil fuel can be used. The use of a heat burner has the advantage that the drying gas has a high percentage of heating gases, which reduces the risk of combustion of combustible or respectively easily combustible material as a result of the greatly reduced oxygen content of the heating gases.

According to a further embodiment, the first and/or the second and/or the third drying step takes place in a manner such that the material passes through a vertical drying path from top to bottom and the drying gas is guided though the drying path in the cross-current flow, wherein the drying path is subdivided into individual sections, in which the mass flow of the drying gas, which is guided transversely through it in a section of the drying path, is adjustable. Larger or smaller volumetric flows of the drying gas can hereby be directed through the drying path in different sections of the drying path. This enables an adjustment for the respectively used material. In the case of a coarser material (e.g. wood chips), repeated deflection of the drying gas at relatively high speeds of the drying gas while passing through the drying path is advantageous because a drying hereby takes place and courser material is less easy to discharge laterally from the drying path. In contrast, in the case of finer material (e.g. shavings), a less frequent deflection and thus a lower flow speed of the drying gas can be advantageous when passing through the drying duct.

According to a further embodiment, the ambient air is heated in that it is suctioned by a fan in a mainly horizontal direction by a box-shaped, vertical arrangement of four heat exchangers and is heated while passing through the heat exchangers and is then suctioned up in the vertical direction by the fan arranged below the heat exchangers and is supplied by it to the second or third drying step. A high heat transfer capacity is hereby reached, whereby the amount of space needed for a device for performing the method is low.

Furthermore, the object is solved by a plant with means for performing the steps of the inventive method.

The plant according to the invention for the drying of wood shavings, woodchips or other solid materials in small pieces that are of organic or mineral origin suitable for performing the inventive method includes:
a first drying unit, which is designed to pre-dry the material in a first drying step by means of a first preheated drying gas,
a second drying unit, which is designed to dry the dried material from the first drying unit by means of a second preheated drying gas,
a gas preparation unit (gas heating unit), which is designed to heat ambient air and provide it as a second preheated drying gas for the second drying unit,
a cooling unit, which is designed to cool the dried material from the second drying stage by means of a cooling gas and
lines, which supply the cooling gas heated in the cooling unit and/or the second drying gas cooled in the second drying unit to a temperature above the ambient temperature as the first drying gas of the first drying unit.

The plant is a preferred form of the implementation of the initially mentioned method and has its energetic advantages.

According to a preferred embodiment, a third drying unit is present, which is designed to dry the material from the second drying unit by means of the second preheated drying gas in a third drying step, and to supply the second drying gas cooled to a temperature above the ambient temperature to the second drying stage. This further improves the energy efficiency of the plant.

According to a further embodiment, the plant comprises a resting container, which is designed so that the dried material from the first drying step or from the second drying step undergoes a rest period in the resting container, in which the water content within the particles of the material is more or less equalized, wherein the material is provided for further drying in the second drying step or in the third drying step after undergoing the rest period. The efficiency of the drying is hereby further improved.

According to a further embodiment, the plant comprises a maceration apparatus, which is designed to macerate the dried material from the first drying unit or from the second drying unit and to provide it for drying in the second drying unit or in the third drying unit. The efficiency of the drying is hereby further improved.

According to a preferred embodiment, the drying plant includes both a resting container as well as a maceration apparatus, generally in any order; however, the material preferably passes through the maceration apparatus before the resting container. Furthermore, the maceration apparatus can be arranged between two different drying units than the resting container.

According to a further embodiment, the first drying unit and/or the second drying unit comprises an outlet to the surroundings for releasing cooled and humidified drying gas. Due to the low temperature of the drying gas in the first drying unit and/or the second drying unit, it only still has a low energy and can be released to the surroundings.

According to a further embodiment, the plant comprises a gas drying unit, which is designed to dry the cooled and humidified drying gas from the second drying unit and provide it for the gas preparation unit for mixing with the ambient air. Thermal energy from the cooled drying gas from the second drying unit can hereby be used to heat the ambient air.

According to a further embodiment, the plant comprises a heat pump, which is designed to raise the heat of the water condensed out in the gas drying unit to an increased temperature level and to provide it to the gas preparation unit in order to heat the ambient air. This further increases the energy efficiency of the plant.

According to a further embodiment, the third drying unit is connected with the line between the cooling unit and the first drying unit via a line, in order to mix cooled, second drying air from the third drying unit with the heated air from the cooling unit and to supply it to the first drying unit as first drying air.

Furthermore, the object is solved by a plant for the drying of wood shavings, woodchips or other solid materials in small pieces that are of organic and/or mineral origin, in particular according to the inventive method, which has a gas preparation unit (gas heating unit) for generating a heated drying gas, which has a rectangular housing with heat exchangers arranged at a distance from the bottom end in four vertical side walls and respectively gas-permeable in the horizontal direction, a fan arranged in the housing below the heat exchangers with an air inlet on the top side and an air outlet, which is connected with a drying unit via a line. The gas preparation unit enables the transfer of high heating capacity with minimal space requirements.

According to a preferred embodiment, each heat exchanger of the gas preparation unit comprises a register and a tube bundle on the inside of the register. This is advantageous for an energetically beneficial pre- and post-heating of the suctioned in drying gas. The tube bundle is also preferably a component of all heat exchangers.

Furthermore, the object is solved by a plant for the drying of wood shavings, woodchips or other solid materials in small pieces that are of organic and/or mineral origin with the inventive method.

The plant according to the invention for the drying of wood shavings and other solid materials in small pieces that are of organic and/or mineral origin, in particular according to the inventive method, comprises a drying unit with at least one vertical drying duct and vertical gas ducts on both sides of the drying duct, wherein the duct walls between the drying duct and the gas ducts are perforated, the drying duct has an inlet on top for the material to be dried and an outlet on the bottom for dried material, at least one of the gas ducts on the bottom end has a gas inlet and at least one of the gas ducts on the top end has a gas outlet and horizontal shut-off apparatuses with an adjustable passage cross-section are arranged within the gas ducts.

In the case of the drying unit, the passage cross-section can be changed from a maximally opened setting to a maximally closed setting. The passage cross-section is preferably infinitely adjustable between the maximally closed and the maximally opened position. In the maximally closed position, the passage cross-section is preferably completely shut, except for inevitable leaks, which the shut-off apparatus can have. By means of shut-off apparatuses, it is possible to adjust the volumetric flow of the drying gas, which is deflected below a shut-off apparatus transversely through the drying duct. By means of the shut-off apparatuses, the flow direction of the drying gas through the drying duct can be changed repeatedly in the one direction and the other. It is also possible to adjust the flow speed of the drying gas in high sections of the drying duct by adjusting the shut-off apparatuses. The drying in the drying unit can hereby be adjusted flexibly for the respective material to be dried.

According to a further embodiment, the duct walls between the drying duct and the gas ducts are perforated sheets. According to a preferred embodiment, the holes in the sheets are covered on the top so that material passing through the drying duct from above is prevented from escaping into a gas duct through the holes in the walls.

According to a preferred embodiment, at least one of the duct walls between the drying duct and gas ducts is guided laterally on the vertical guide apparatuses and is connected with a displacement apparatus on the upper end, which is designed to displace the duct wall within the guide apparatuses upwards and downwards vertically in order to break down material bridges between the duct walls of the drying duct. A blocking of the drying duct by the material to be dried can hereby be prevented.

According to a further embodiment, both duct walls on the upper end are connected with a displacement apparatus, wherein the displacement apparatuses are synchronized so that they displace the two duct walls in the opposite direction. Material bridges between the duct walls of the drying duct are hereby broken down particularly effectively.

According to a further embodiment, the shut-off apparatuses are lamella apparatuses each with at least one lamella pivotable about a horizontal axis. Different passage cross-sections can be released by pivoting the lamella. Each shut-off apparatus preferably comprises several parallel lamellas pivotable about a horizontal axis.

According to a further embodiment, drying ducts are arranged on both sides of a gas duct supplying a drying gas, and an exterior gas duct is arranged on the outsides of each drying duct. A particularly compact construction of a drying unit with a high efficiency is hereby achieved.

According to a further embodiment, which concerns all plants according to the invention, at least one component is arranged in at least one container, wherein a container accommodates entirely or partially one or more components of the plant. This embodiment is particularly easy to install and suitable for mobile use at different locations. The plant is preferably designed so that the components are arranged entirely or partially in several containers, which can be combined to form at least one main part of the plant.

Containers in terms of the present application are preferably frame constructions with open walls or with one or more closed walls. The frame construction preferably has packing and connecting dimensions and properties like stackability, transportability, fastening amongst each other etc., according to the ISO standard ISO 668:2013. The containers preferably have self-supporting frame constructions. The frame constructions are preferably simultaneously an integral structural part of one or more components of the plant. The components or respectively the machines contained therein are permanently integrated into the frame construction. The embodiment of the containers preferably differs from the embodiment of conventional standard containers, e.g. with respect to load-bearing capacity, frame strength, number and type of struts, etc. However, within the framework of the invention, conventional standard containers can generally also be used for accommodating components or parts thereof.

According to a further embodiment, the gas preparation unit and/or the drying unit is/are arranged entirely or partially in a vertical container. With respect to the structural design of the cooling unit and the gas preparation unit, this embodiment is particularly effective and space-saving.

According to a preferred embodiment, at least one structural element of one component of the plant is at least one structural element of the container. According to a preferred embodiment, at least one structural element of the gas preparation unit and/or the drying unit is a component of the frame construction and/or the container shell. At least one frame part and/or one outer wall of the gas preparation unit and/or the drying unit is preferably a structural element, which is simultaneously at least partially a component of the container shell. As a component of the container shell, the structural element simultaneously forms at least partially the outer shell of the container.

The invention will be further explained below with reference to the accompanying drawings of exemplary embodiments. The drawings show in:

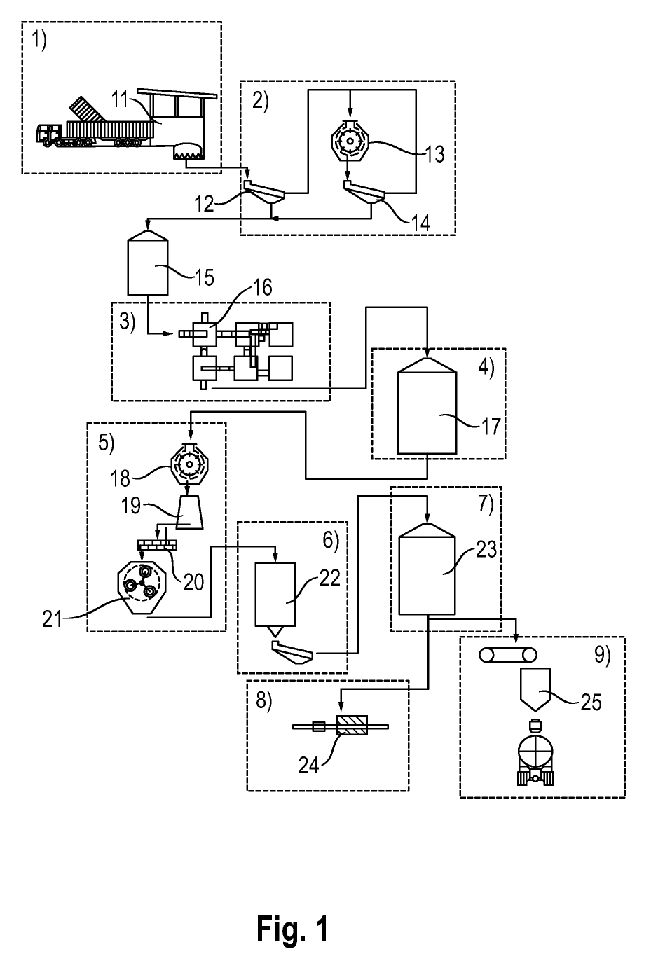

FIG. 1 a plant for producing wood pellets in a roughly schematic representation;

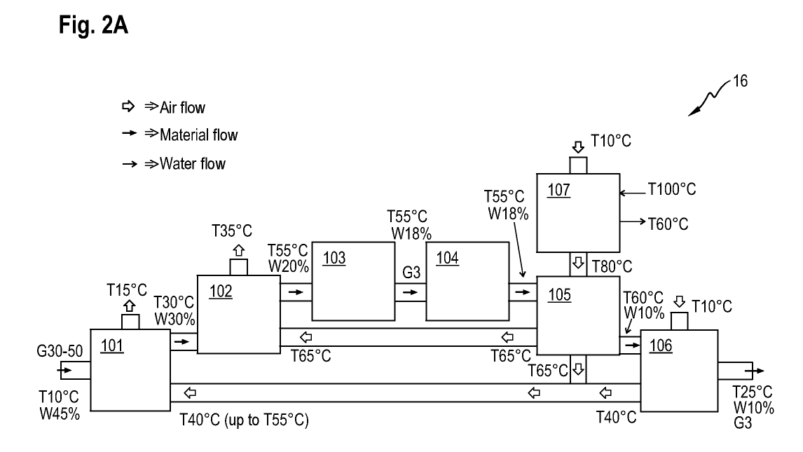

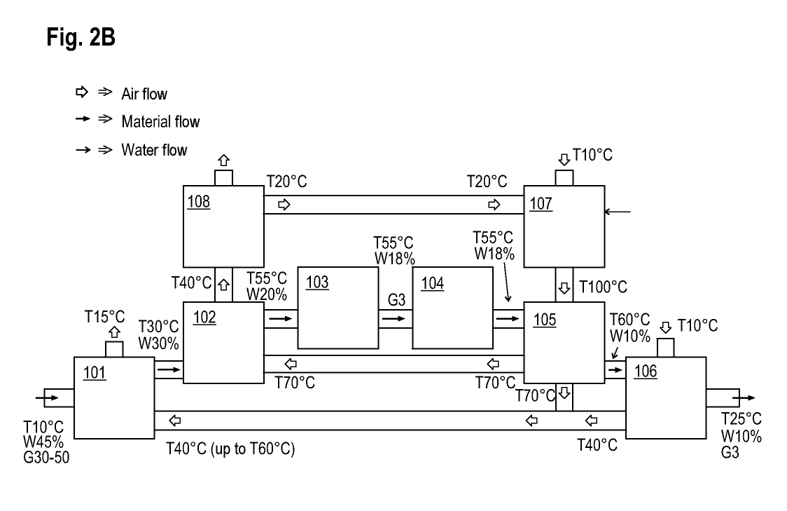

FIG. 2A a first version of a plant for drying for the plant for producing wood pellets in a schematic representation;

FIG. 2B a second version of a plant for drying for the plant for producing wood pellets in a schematic representation;

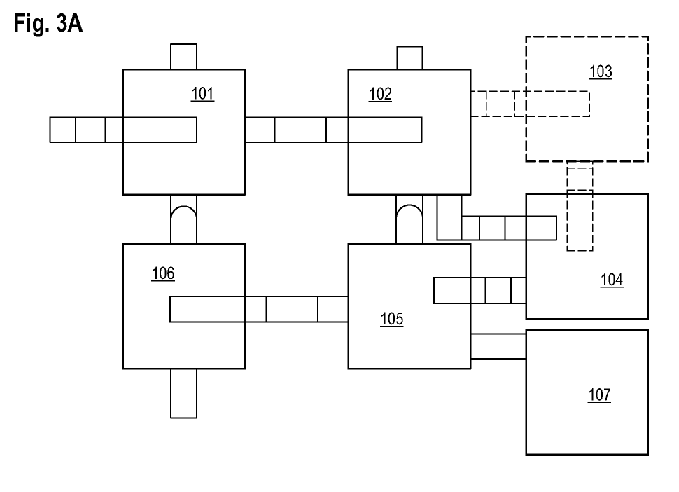

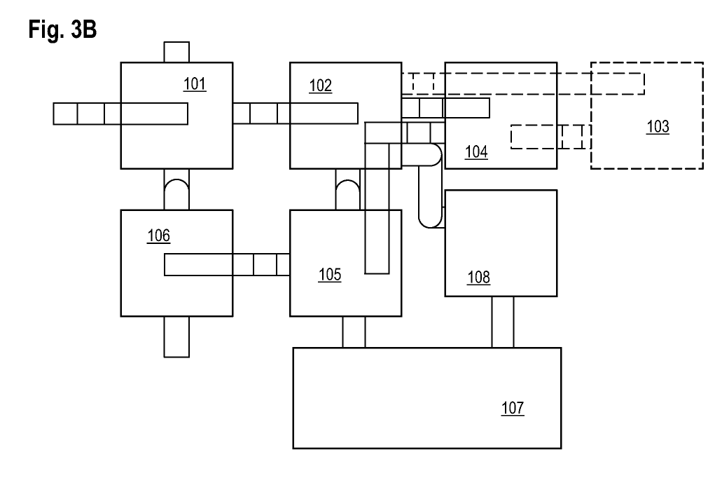

FIG. 3A setup of the components of the plant in FIG. 2A in a plan view;

FIG. 3B setup of the components of the plant in FIG. 2B in a plan view;

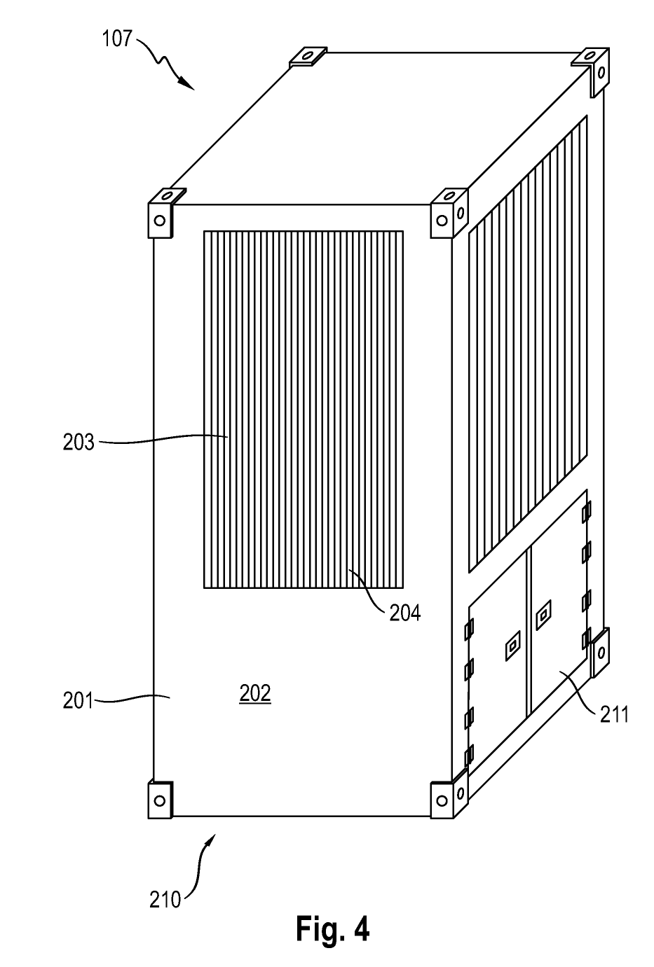

FIG. 4 a gas preparation unit of the same plant in a perspective view transversely from the side;

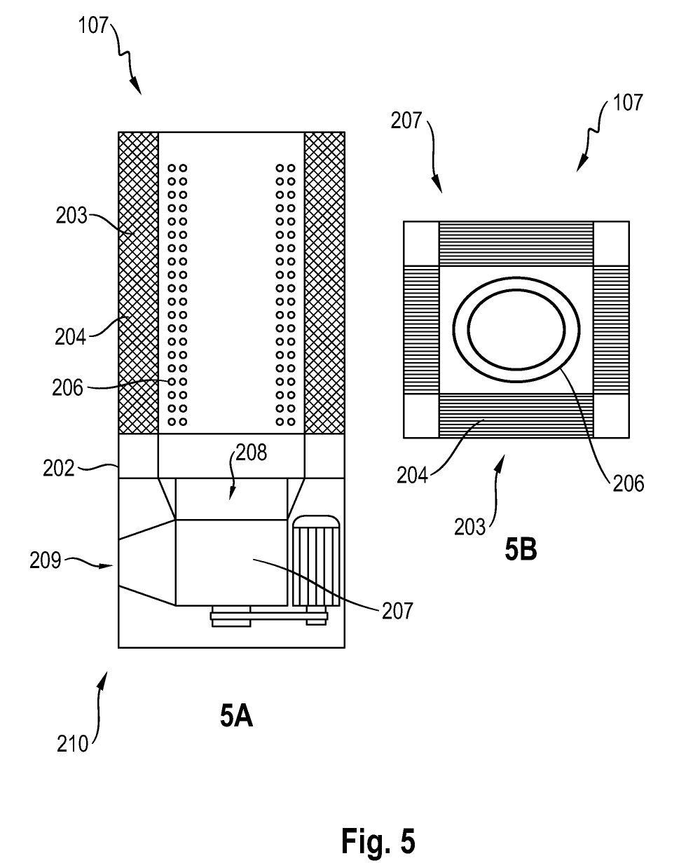

FIGS. 5A+B the same gas preparation unit in a vertical section (FIG. 5A) and in a horizontal section (FIG. 5B);

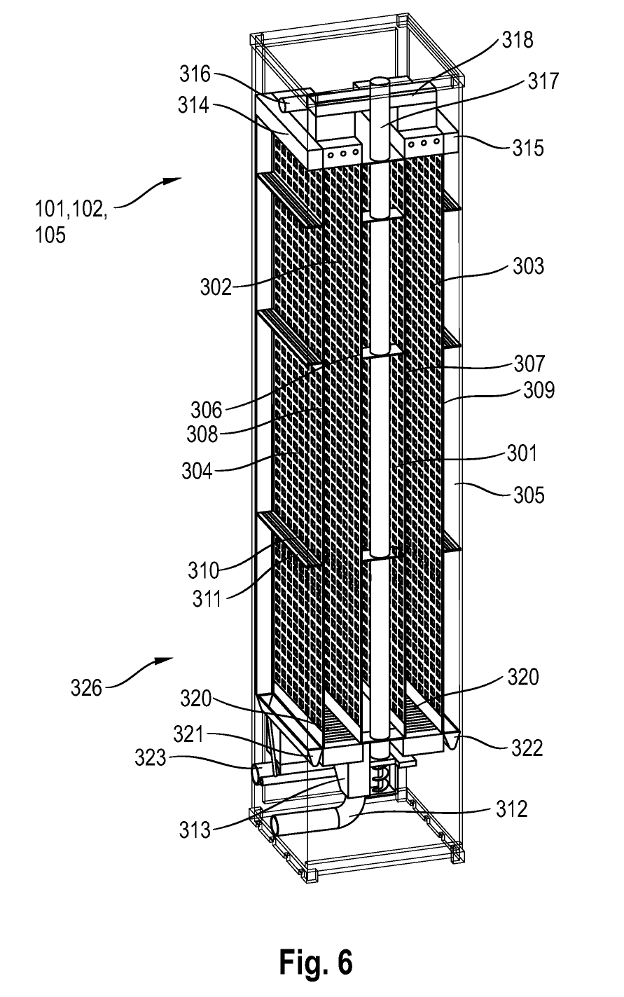

FIG. 6 a drying unit of the same plant in a perspective X-Ray image;

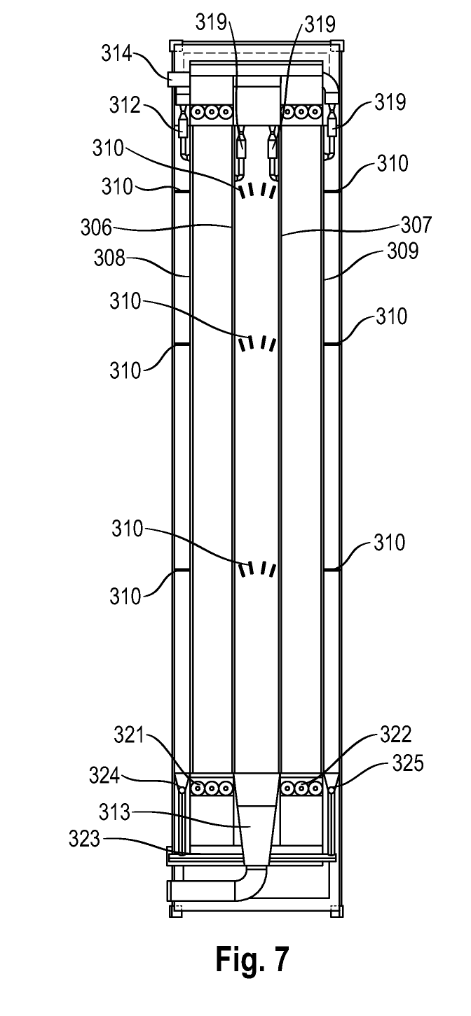

FIG. 7 the same drying unit in a vertical section;

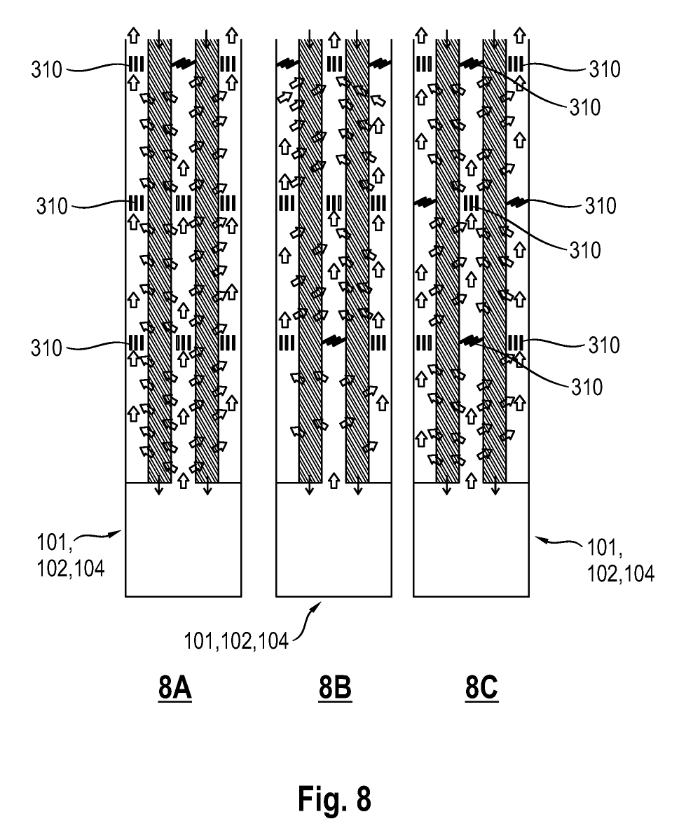

FIG. 8A-B the same drying unit with different settings of the shut-off apparatuses, respectively in a roughly schematic vertical section.

In FIG. 1, different modules of a plant for producing wood pellets are framed by dashed lines. Preferably, the modules each consist of one or more containers containing the components of the plant. This is the case in the example in modules 1, 2, 5, 6, 8 and 9. The module 3 comprises a plant for drying according to the invention and the modules 4 and 7 are silos in the example.

Raw materials such as sawdust or wood chips are delivered in a truck and unloaded in the raw material receiving unit 11. If applicable, the raw material may be stored sorted according to quality, or respectively properties, on a site and supplied to the plant in appropriate mixtures, for example using a wheel bearing. The raw material is fractionated in the plant by means of the sieve 12. Coarse fraction is macerated in the wet macerator 13. After being macerated in the wet macerator 13 and passing through a sieve 14, the fine fraction together with the fine fraction from the sieve 12 is also added to the buffer and metering tank 15.

This is followed by the drying in the plant for drying 16 and subsequent interim storage in the storage silo 17. Next comes the metered conveyance to a dry mill 18 where the material is macerated to the optimum grain size. Then the material is prepared to be pressed in a conditioner 19. After passing through a mixing worm gear 20 into which binding agent may be supplied, the prepared raw material enters a press 21.

Following the pressing process in the press 21, hot pellets are cooled in a cooler 22 and introduced into the storage silo 23 to be stored. After being stored in the storage silo 23, the pellets are packaged into small packages in a packaging plant 24 or are loaded directly as bulk material in a loading plant 25.

The explanation of two alternative plants for drying 16 takes place based on FIGS. 2a, b and 3a, b. In FIGS. 2a and b, the temperatures of the drying gas are noted in degrees Celsius and the humidities of the material in weight percent at different positions in the plant. In both alternatives, ambient air with a temperature of 10° C. and 70% relative humidity is supplied to the plant. The supplied material consists of wood chips with a water content of 45 wt.-percent and an average particle size ranging from 30 to 50 mm.

In both alternatives, the material to be dried passes through in succession a first drying unit 101, a second drying unit 102, an intermediate macerator 103, a resting container 104, a third drying unit 105 and a cooling unit 106.

In both alternatives, ambient air is heated in a gas preparation unit 107 and supplied to the third drying unit 105 as a second preheated drying gas. The second drying gas cooled to a temperature above the ambient temperature by the heating of the material in the third drying unit 105 is supplied to the second drying unit 102 in order to dry the material supplied to this drying unit from the first drying unit 101.

The cooling unit 106 is supplied with ambient air for the cooling of the material heated during the drying in the third drying unit 105.

The ambient air heated in the cooling unit 106 is supplied to the first drying unit 101 as the first drying gas in order to pre-dry the material supplied to it.

The material pre-dried in the first drying unit 101 is dried further in the second drying unit 102.

After the second drying unit 102, the material is macerated in the maceration unit 103, in order to release the moisture on the surface of the material. It is then stored for a certain rest period of e.g. one to one and a half hours in the resting container 103 so that the liquid is equalized over the cross-section of the particles.

After the rest period, the material is completely dried in the third drying unit 105. Finally, it is cooled in the cooling unit 106.

The dried material then enters the storage silo 17.

The first drying gas cooled in the first drying unit 101 is released into the surroundings. In the alternatives in FIG. 2A, the second drying gas cooled in the second drying unit 102 is released into the surroundings. In the alternatives in FIG. 2B, the second drying gas cooled and humidified in the second drying unit 102 is supplied to a gas drying unit 108. In the gas drying unit 108, the gas temperature is lowered for example by spraying with water and a steam condensation is performed. The condensed water from the sump of the gas drying unit 108 can be supplied to a heat pump, which brings the thermal energy to a suitable temperature level for the drying gas preparation. The drying gas dried in the gas drying unit 108 is mixed with the ambient air in the gas preparation unit 107.

The gas preparation unit 107 in the alternatives in FIG. 2A works with a heat exchanger, which is supplied with heating medium at a temperature of e.g. 100° C., which leaves the heat exchanger at e.g. 60° C. The second drying gas is heated to a temperature of approx. 80° C. The alternative in FIG. 2B has a burner. The fuel is for example dried and finely macerated biomass (e.g. wood dust). This design is particularly suited and preferred for setup and locations without or with insufficient external heat sources (CHP—combined heat and power) plants, process waste heat, etc.).

A further advantage of the gas preparation unit 107 with burner is the improvement of operational safety, since the use of the low-oxygen exhaust gas from the gas preparation unit 107 virtually effectuates fire protection in closed-circuit mode. Only the amount of air necessary for the complete combustion of the fuel is supplied so that the hot combustion gas (e.g. approx. 600° C. to 800° C.) with the dried drying gas from the gas drying unit 108 is mixed to form a second drying gas with the desired drying gas temperature (approx. 100° C.) and is supplied to the third drying stage 105. The heating of the drying gas to a temperature of max. 120° C., preferably max. 100° C., reduces at least the volatilization of high-energy components of the material that are important for the production of wood pellets, e.g. lignin. The low drying temperature also reduces the fire risk.

The structure and functionality of an exemplary embodiment of the gas preparation unit 107 is explained based on FIGS. 4 and 5.

The gas preparation unit 107 has a rectangular housing 201 with heat exchangers 203 arranged at a distance from the bottom end in four vertical side walls 202 and respectively gas-permeable in the horizontal direction. Each heat exchanger 203 comprises a plate-like register 204, which is arranged in the opening 205 of a side wall 202. Furthermore, the heat exchangers 203 comprise a tube bundle 206, which is designed as a spiral, spirally wound tube coil with vertical winding axis.

Below the heat exchangers 203, a fan 207 with vertical air inlet 208 and radial air outlet 209 through a side wall of the housing is arranged in the housing 201.

The gas preparation unit 107 is designed as a container 210, i.e. it has the dimensions of a standard container. The side walls 202 are an integral component of the container shell. Revision flaps 211 are present in one of the side walls on the bottom.

The container 210 can be transported in horizontal alignment. During operation, it has the vertical alignment shown in FIG. 4.

The fan 207 suctions the ambient air to be heated through the register 204 and through the tube bundle 206. When passing through the register 204, the ambient air is preheated and is post-heated when passing through the tube bundle 206. The preheated drying gas enters e.g. the third drying unit from the gas preparation unit 107.

The tube bundle 206 is preferably designed as a fin tube bundle and serves as a second heating stage. Hot water or another suitable liquid/mixture first passes through the tube bundle 206 and then through the register 204. After passing through the registers 204, the cooled medium is lead back to the external heat source as return flow.

The registers 204 are preferably lamella heat registers. The fan 207 is e.g. a radial ventilator or a side-channel compressor.

The gas preparation unit 107 has a particularly good surface area utilization and an improved utilization of the supplied heat. Moreover, through the arrangement of the heat exchangers 203 in the upper area, the contamination of the gas preparation unit 107 with swirling dust on the floor is reduced. This increases the efficiency of the heat exchangers 203 and extends the cleaning intervals.

Based on FIGS. 6 to 8, the structure and function of one of the drying units 101, 102, 105 designed as a duct dryer is explained.

The duct dryer 101, 102, 105 has a central vertical gas duct 301 and drying ducts 302, 303 on both sides of the gas duct. The duct dryer has outer gas ducts 304, 305 on both outsides of the drying ducts 302, 303.

The gas ducts 301, 304, 305 and drying ducts 301, 303 are separated from each other by perforated duct walls 306, 307, 308, 309, which are preferably designed as perforated sheets.

The drying ducts 302, 303 and gas ducts 301, 304, 305 have respectively a mainly rectangular cross-section.

Shut-off apparatuses 310 with an adjustable passage cross-section, which are designed as lamella apparatuses each with at least one lamella 311 infinitely pivotable about a horizontal axis, are arranged within the gas ducts 301, 304, 305. In the example, there are three lamellas 311 per shut-off apparatus 310.

In the example, the shut-off apparatuses 310 are arranged in the vertical direction at three positions distributed almost evenly across the height of the duct dryer.

Drying gas is supplied to the central gas duct on the bottom via an inlet line 312 and a distributing funnel 313. Collector lines 314, 315 are present on the upper end of the outer gas ducts 304, 305, through which the humidified and cooled drying gas enters a discharge line 316.

The material to be dried is supplied via a filling apparatus, which is designed for example as a vertical worm gear 317. In the vicinity of the bottom end, the worm gear 317 catches supplied material and transports it up to near the upper end of the duct dryer 101, 102, 105. There, the material is supplied to distribution apparatuses 318, which supply it to the upper ends of both drying ducts 302, 303.

The duct walls 306, 307, 308, 309 of the drying ducts 302, 303 are guided on vertical guide apparatuses on their perpendicular edges. On top, each duct wall 306, 307, 308, 309 is connected with a displacement apparatus 319, which is designed to raise and lower the duct wall vertically, for example over a distance of a few centimeters (e.g. 5 to 10 cm). The displacement apparatuses are synchronized such that they displace the walls, which delimit the same drying duct 302, 303, in the opposite direction. Each displacement apparatus 319 is e.g. a hydraulic displacement apparatus, in particular a hydraulic cylinder. Each displacement apparatus 319 is preferably arranged in a gas duct 301, 304, 305.

A grooved floor 320 is present on the bottom end of each drying duct 302, 303, through which the dried material can be released in a controlled manner. By means of a spiral floor 321, 322, the released material is guided into a collection and discharge spiral 323.

The refilling of the drying ducts 302, 303 is controlled so that the drying ducts are completely filled with the material to be dried and no false air is created.

The duct walls 306, 307, 308, 309 are perforated so that material cannot pass through laterally and fall into a gas duct 301, 304, 305.

The drying gas passes through the inlet line 312 and the distribution funnel 313 into the central gas duct 301 and flows transversely through the perforated duct walls 306, 307, 308, 309 through the drying ducts 302, 303. The drying gas enters the collection lines 314, 315 through the outer gas ducts 304, 305 and is then removed by the discharge line 316.

The guiding and quantity distribution of the drying gas in the drying ducts 302, 303 takes place by means of shut-off apparatuses 310. These can be more or less open. It is hereby possible, depending on the material properties (particle size, bulk density, etc.) and the flow rate (kg per hour) of the material to be dried, to set the guiding of the drying gas via the different height sections of the drying ducts 302, 303.

In the case of fine-grain raw materials with a large surface area and large air resistance, a simple crossing of the drying duct 302, 303 can be advantageous, as shown in FIG. 8A. In the case of course-grain raw materials with correspondingly lower air resistance, single or multiple crossings can be advantageous, as shown in FIGS. 8B and C. Fine particles, which unintentionally enter the gas ducts 304, 305, can be distributed by means of spirals 324, 325, which are located on the bottom end of the outer drying ducts 304, 305.

Furthermore, the guiding of the drying gas according to FIGS. 8B and C is advantageous during partial load mode or when the plant is setup for low hourly output. It is thereby possible to design the plant with two instead of three drying stages.

In another design, it is possible to dry material to considerably lower water contents of e.g. 4 wt.-% or 2 wt.-% by designing the duct dryer 101, 102, 105 with additional drying ducts and gas ducts.

The duct dryer 101, 102, 105 is preferably designed in a single container 326. The outer walls of the ducts 301 to 305 thereby simultaneously form parts of the shell of the container 326. The container 326 is horizontally transportable and is set up vertically during operation, as shown in FIGS. 6 to 8.

1. A process for the drying of wood shavings, woodchips or other solid materials in small pieces that are of organic and/or mineral origin, in which
in a first drying step, the material is pre-dried by means of a first preheated drying gas,
in a second drying step, the dried material from the first drying step is dried by means of a second preheated drying gas,
ambient air is heated and supplied to the second drying step as a second preheated drying gas,
the dried material from the second drying step is cooled by means of a cooling gas and
the cooling gas heated by the cooling of the material and/or the second drying gas cooled in the second drying step is supplied to the first drying step as the first drying gas.

2. The process according to claim 1, in which, in a third drying step, the dried material from the second drying step is dried by means of the second preheated drying gas and the second preheated drying gas cooled in the third drying step to a temperature above the temperature of the ambient air is supplied to the second drying step.

3. The process according to claim 1, in which the dried material from the first or the second drying step undergoes a rest period, in which the water content within the particles of the material are more or less equalized, and the material is dried in the second or third drying step after the rest period is complete.

4. The process according to claim 1, in which the dried material from the first drying step or from the second drying step is macerated and then supplied to the second drying step or the third drying step.

5. The process according to claim 1, in which the cooled and humidified drying gas from the first drying step and/or from the second drying step is released into the surroundings.

6. The process according to claim 1, in which the cooled and humidified drying gas from the second drying step is dried and the dried drying gas is mixed with the ambient air and is supplied to the second or third drying step as a second drying gas.

7. The process according to claim 1, in which, the condensed water coming from the drying of the drying gas from the second drying step is supplied to a heat pump and the heat brought to an increased temperature level by the heat pump is used to heat the ambient air.

8. The process according to claim 1, in which a part of the cooled, second drying gas from the third drying step is mixed with the heated cooling gas and is supplied to the first drying step as the first drying gas.

9. The process according to claim 1, in which the ambient air and/or the dried drying gas is heated by means of heat exchangers and/or by means of a heat burner.

10. The process according to claim 1, in which the first and/or the second and/or the third drying step is performed in a manner such that the material passes through a vertical drying path from top to bottom and the drying gas is guided though the drying path in the cross-counterflow, wherein the drying path is subdivided into individual sections, in which the mass flow of the drying gas, which is guided transversely though it in a section of the drying path, is adjustable.

11. The process according to claim 1, in which the ambient air is heated in that it is suctioned by a fan in a mainly horizontal direction by a box-shaped, vertical arrangement of four heat exchangers and is heated while passing through the heat exchangers and is then suctioned up in the vertical direction by the fan arranged below the heat exchangers and is fed by it to the second or third drying step.

12. A plant for the drying of wood shavings, woodchips or other solid materials in small pieces that are of organic and/or mineral origin suitable for performing the process according to claim 1, including:
a first drying unit (101), which is designed to pre-dry the material in a first drying step by means of a first preheated drying gas,
a second drying unit (102), which is designed to dry the dried material from the first drying unit (101) by means of a second preheated drying gas,
a gas preparation unit (107), which is designed to heat ambient air and make it available as a second preheated drying gas for the second drying unit (102),
a cooling unit (106), which is designed to cool the dried material from the second drying unit (102) by means of a cooling gas and
lines, which supply the cooling gas heated in the cooling unit (106) and/or the second drying gas cooled in the second drying unit (102) to a temperature above the ambient temperature as the first drying gas of the first drying unit (101).

13. The plant according to claim 12, which has a third drying unit (105), which is designed to dry the material from the second drying unit (102) by means of the second preheated drying gas in a third drying step, and to supply the second drying gas cooled to a temperature above the ambient temperature to the second drying unit (102).

14. The plant according to claim 12, which comprises a resting container (104), which is designed so that the dried material from the first drying step or from the second drying step undergoes a rest period in the resting container (104), in which the water content within the particles of the material is more or less equalized, wherein the material is made available for further drying in the second drying step or in the third drying step after undergoing the rest period.

15. The plant according to claim 12, which comprises a maceration apparatus (103), which is designed to macerate the dried material from the first drying unit (101) or from the second drying unit (102) and to make it available for drying in the second drying unit (102) or in the third drying unit (105).

16. The plant according to claim 12, in which the first drying unit (101) and/or the second drying unit (102) has an outlet to the surroundings for releasing cooled and humidified drying gas.

17. The plant according to claim 12, which comprises a gas drying unit (108), which is designed to dry the cooled and humidified drying gas from the second drying unit (102) and make it available to the gas preparation unit (107) for mixing with the ambient air.

18. The plant according to claim 12, comprising a heat pump, which is designed to raise the heat of the water condensed out in the gas drying unit (108) to an increased temperature level and to make it available to the gas preparation unit (107) in order to heat the ambient air.

19. The plant according to claim 12, in which the third drying unit (105) is connected with the line between the cooling unit (106) and the first drying unit (101) via a line, in order to mix cooled, second drying air from the third drying unit with the heated air from the cooling unit (106) and to supply it to the first drying unit (101) as first drying air.

20. The plant for the drying of wood shavings, woodchips or other solid materials in small pieces that are of organic and/or mineral origin, in particular according to claim 12, which has a gas preparation unit (107) for generating a heated drying gas, which has a rectangular housing (201) with heat exchangers (203) arranged in a distance from the bottom end in four vertical side walls (202) and respectively gas-permeable in the horizontal direction, a fan (207) arranged in the housing (201) below the heat exchangers (203) with an air inlet (208) on the top side and an air outlet (209), which is connected with the drying unit via a line.

21. The plant according to claim 20, in which each heat exchanger (203) of the gas preparation unit (107) has a register (204) and a tube bundle (206) on the inside of the register.

22. The plant for the drying of wood shavings, woodchips or other solid materials in small pieces, in particular according to claim 12, comprising a drying unit (101, 102, 105) with at least one vertical drying duct (302, 303) and vertical gas ducts (301, 304, 305) on both sides of the drying duct (302, 303), wherein the duct walls (306 to 309) between the drying duct (302, 303) and the gas ducts (301, 304, 305) are perforated, the drying duct (302, 303) has an inlet on top for the material to be dried and an outlet on the bottom for dried material, at least one of the gas ducts (301, 304, 305) on the bottom end has a gas inlet and at least one of the gas ducts on the top end has a gas outlet and horizontal shut-off apparatuses (310) with an adjustable passage cross-section are arranged within the gas ducts (301, 304, 305).

23. The plant according to claim 22, in which the duct walls between the drying duct (302, 303) and the gas ducts (301, 304, 305) are perforated sheets.

24. The plant according to claim 22, in which at least one of the duct walls (306 to 309) between the drying duct (302, 303) and gas ducts (301, 304, 305) is guided laterally on vertical guiding apparatuses and is connected on the upper end with a displacement apparatus, which is designed to displace the duct wall (306 to 309) vertically upwards and downwards within the guiding apparatuses.

25. The plant according to claim 24, in which both duct walls (306 to 309) on the upper end are connected with a displacement apparatus, wherein the displacement apparatuses are synchronized so that they displace in the opposite direction the two duct walls (306 to 309).

26. The plant according to claim 22, in which the shut-off apparatuses (310) are lamella apparatuses each with at least one lamella (311) pivotable about a horizontal axis.

27. The plant according to claim 22, in which drying ducts (302, 303) are arranged on both sides of a gas duct (301) supplying a drying gas, and a further gas duct (304, 305) is arranged on the outsides of each drying duct (302, 303).

28. The plant according to claim 12, in which at least one component is arranged in at least one container (210, 326), wherein a container accommodates entirely or partially one or more components of the plant.

29. The plant according to claim 12, in which the gas preparation unit (107) and/or the drying unit (101, 102, 105) are arranged in a vertical container (210, 326).

30. The plant according to claim 28, in which at least one structural element of the gas preparation unit and/or the drying unit is simultaneously a structural element of the container (210, 326).

31. A process for the drying of wood shavings, woodchips or other solid materials in small pieces that are of organic and/or mineral origin, comprising the steps of:
pre-drying the material in a first drying step using a first preheated drying gas;
drying the dried material from the first drying step in a second drying step using a second preheated drying gas;
heating the ambient air and supplying it to the second drying step as a second preheated drying gas;
cooling the dried material from the second drying step using a cooling gas, and
wherein the cooling gas heated by the cooling of the material and/or the second drying gas cooled in the second drying step is supplied to the first drying step as the first drying gas.
